(19) United States
(12) Patent Application Publication
(10) Pub. No.: US 2017/0142118 A1
(43) Pub. Date: May 18, 2017

(54) DOWNLOADING A USER CONTENT PORTION TO AN UNAUTHORIZED USER ELECTRONIC DEVICE

(71) Applicant: YANDEX EUROPE AG, Luzern (CH)

(72) Inventors: Aleksey Aleksandrovich ANDROSOV, Bryansk, Bryansk region (RU); Mikhail Aleksandrovich KOREPANOV, Korolev, Moscow region (RU)

(21) Appl. No.: 15/102,367

(22) PCT Filed: Jun. 29, 2015
(86) PCT No.: PCT/IB15/54884

§ 371 Date: Jun. 7, 2016

(30) Foreign Application Priority Data
Mar. 31, 2015 (RU) 2015111607

(51) Int. Cl. H04L 29/06

(52) U.S. Cl. CPC H04L 63/102; H04L 63/08; H04L 63/0876

(57) ABSTRACT

A method of downloading to an electronic device a portion of content of a personal webpage of a registered user of a web service before obtaining complete identification credentials of the registered user, and a server implementing the method, the method comprising: determining that the electronic device has accessed a starting page of the web service, the starting page of the web service being configured to allow entry of identification credentials of registered users; obtaining from the electronic device at least one parameter that is different from the registered user's complete identification credentials; before obtaining the registered user's complete identification credentials, based on at least one parameter that is different from the registered user's complete identification credentials of the registered user, performing a search for a probable registered user, who has most probably, accessed the starting page of the web service using the electronic device and, responsive to the server locating the probable registered user successfully, acquiring an indication of an account of the probable registered user and calculating a value of probability that the probable registered user is the registered user; transmitting to the electronic device, before obtaining the complete identification credentials of the registered user, at least one portion of content of the personal webpage of the registered user, wherein the at least one portion of content of the personal webpage of the registered user transmitted by the server to the electronic device is determined based on the value of probability that the probable registered user is the registered user.

### CROSS-REFERENCE

The present application claims priority to Russian Patent Application No. 2015111607, filed Mar. 31, 2015, entitled “C [symbol] CTEMA [symbol] CΠOCO [symbol] 3AΓP [symbol] 3 [symbol] [symbol] [symbol] ACT [symbol] [symbol] OHTEHTA ΠO [symbol] [symbol] 3OBATE [symbol] [symbol] HA [symbol] [symbol] E [symbol] TPOHHOE [symbol] CTPO\check{}CTBO HEABTOP [symbol] 3 [symbol] POBAHHOΓO ΠO [symbol] [symbol] 3OBATE [symbol] [symbol] ” the entirety of which is incorporated herein.

### FIELD OF THE TECHNOLOGY

The present technology relates to system for and method of downloading a portion of user content to an electronic device of an unauthorized user.

### BACKGROUND

Nowadays, users of electronic devices tend to have high expectations regarding the speed for downloading content onto their electronic devices. This problem can be solved in part by continuously increasing the speed of data transmission on local networks and on the Internet.

However, increasing the speed of data transmission is not the only way of improving the user experience. Another mechanism allowing to do so is by preloading content from websites onto user electronic devices. Such challenges can be solved in different ways. For example, US 20080201332 A1 “System and method for preloading content on the basis of user context [symbol] ,” teaches that it is possible to predict which site a user wants to load and perform the preloading before the user sends the request to provide this website. Thus, the content of a website corresponding to a hyperlink to which the user moves the cursor can be downloaded onto the electronic device. In case where the user selects the given hyperlink, the content will be quickly downloaded from the cache where it will have been pre-downloaded.

However, some webpages are protected by passwords or other means of limiting access thereto. For example, such webpages can be pages of web services. Thus, although the conventional computer systems are acceptable, improvement of such systems is still possible.

### SUMMARY

It is an object of the present technology to ameliorate at least some of the inconveniences present in the prior art.

According to a first broad aspect of the present technology, there is provided a method of downloading a portion of content of a personal webpage of a registered user of a web service to an electronic device. The method is implemented on a server. The server is connected to electronic devices via a communication network. The server has access to a plurality of registered accounts of a plurality of users of the web service. Each of the registered accounts is associated with the data of the corresponding account of the corresponding registered user. The method comprises: determining that the electronic device has accessed a starting page of the web service, the starting page of the web service being configured to allow entry of identification credentials of registered users; obtaining from the electronic device at least one parameter that is different from the registered user's complete identification credentials; before obtaining the registered user's complete identification credentials, based on at least one parameter that is different from the registered user's complete identification credentials of the registered user, performing a search for a probable registered user, who has most probably, accessed the starting page of the web service using the electronic device and, responsive to the server locating the probable registered user successfully, acquiring an indication of an account of the probable registered user and calculating a value of probability that the probable registered user is the registered user; transmitting to the electronic device, before obtaining the complete identification credentials of the registered user, at least one portion of content of the personal webpage of the registered user, wherein the at least one portion of content of the personal webpage of the registered user transmitted by the server to the electronic device is determined based on the value of probability that the probable registered user is the registered user.

In some implementations of the present technology, the at least one parameter that is different from the registered user's complete identification credentials comprises at least one of an identification code of the electronic device, information about the software installed on the electronic device, information about the hardware that is part of the electronic device, information about the hardware associated with the electronic device, information contained in a cookie file, information contained in an auto-fill file of a web browser, web browser settings, web browser navigation history, an IP address of the electronic device, location information associated with the electronic device, a phone number and an international mobile equipment identify (IMEI).

In some implementations of the present technology, at least one of the performing the search for the probable registered user and the calculating the value of probability that the probable registered user is the registered user is performed by comparing the at least one parameter that is different from the registered user's complete identification credentials obtained from the electronic device with at least a portion of comparable information stored on the server.

In some implementations of the present technology, the server further effects storing of a characteristic of a previous activity of the registered user, and at least one of searching for the probable registered user and calculating the value of probability that the probable registered user is the registered user is additionally performed by comparing a characteristic of a current activity of the probable registered user with the characteristic of the previous activity of the registered user stored on the server.

In some implementations of the present technology, the characteristics of the previous activity of the user include at least one of a personal preference of the registered user, navigation history of the web browser and a temporary pattern of the registered user's behavior.

In some implementations of the present technology, when the value of probability that the probable registered user is the registered user exceeds a first re-determined value, the transmitting comprises sending a first portion of content of the personal webpage of the registered user to the electronic device, and when the value of probability that the probable registered user is the registered user exceeds a second re-determined value, the second re-determined value exceeding the first re-determined value, the transmitting comprises sending the first portion of content of the personal webpage of the registered user and a second portion of content of the personal webpage of the registered user to the electronic device.

In some implementations of the present technology, the first portion of the content of the personal webpage of the registered user is at least one of page layout information, a background image and a visual style.

In some implementations of the present technology, the registered user is a group of users using one common user account and shared identification credentials, and the probable registered user is a probable member of the group of users using the one common user account and the shared identification credentials.

Another object of the present technology is a server. The server is connected to electronic devices via a communication network. The server has access to a plurality of registered accounts of a plurality of users of the web service. Each of the registered accounts is associated with data of a corresponding account of a corresponding registered user. The server includes a processor. The processor is configured to render the server to execute: determining that the electronic device has accessed a starting page of a web service, the starting page of the web service being configured to allow users to allow entry of identification credentials of registered users; obtaining from the given electronic device at least one parameter that is different from the registered user's complete identification credentials; before obtaining the registered user's complete identification credentials, based on at least one parameter that is different from the registered user's complete identification credentials, performing a search for a probable registered user, who has most probably accessed the starting page of the web service using the electronic device and, if the server located the probable registered user successfully, obtaining an account of the probable registered user and calculating the value of probability that the probable registered user is the registered user; transmitting to the electronic device, before obtaining the complete identification credentials of the registered user, at least one portion of content of the personal webpage of the registered user, wherein the at least one portion of the content of the personal webpage of the registered user transmitted by the server to the electronic device is determined based on the value of probability that the probable registered user is the registered user.

In some implementations of the server, the at least one parameter that is different from the registered user's complete identification credentials includes at least one of an identification code of the electronic device, information about the software installed on the electronic device, information about the hardware that is part of the electronic device, information about the hardware associated with the electronic device, information contained in a cookie file, information contained in an auto-fill file of a web browser, web browser settings, web browser navigation history, IP address of the electronic device, location information associated with the electronic device, a phone number and an international mobile equipment identify (IMEI).

In some implementations of the server, the processor is further configured to render the server to effect at least one of the performing the search for the probable registered user and the calculating the value of probability that the probable registered user is the registered user is performed by comparing the at least one parameter that is different from the registered user's complete identification credentials obtained from the electronic device with at least a portion of comparable information stored on the server.

In some implementations of the server, the server further effects storing of a characteristic of a previous activity of the registered user, and at least one of the searching for the probable registered user and the calculating the value of probability that the probable registered user is the registered user is additionally performed by comparing a characteristic of a current activity of the probable registered user with the characteristic of the previous activity of the registered user stored on the server.

In some implementations of the server, the characteristic of the previous activity of the user includes at least one of a personal preference of the registered user, navigation history of the web browser and a temporary pattern of the registered user's behavior.

In some implementations of the server, the processor is further configured to render the server to execute: when the value of probability that the probable registered user is the registered user exceeds a first preset value, sending to the electronic device a first portion of content of the personal webpage of the registered user, and when the value of probability that the probable registered user is the registered user exceeds a second preset value, the second preset value exceeding the first preset value, sending to the electronic device the first portion of content of the personal webpage of the registered user and a second portion of the content of the personal webpage of the registered user.

In some implementations of the server, wherein the first portion of content of the personal webpage of the registered user is at least one of page layout information, a background image and a visual style.

In some implementations of the server, the registered user is a group of users using one common user account and shared identification credentials, and the probable registered user is a probable member of the group of users using the one common user account and shared identification credentials.

In the context of the present specification, a “server” is a computer program that is running on appropriate hardware and is capable of receiving requests (e.g., from electronic devices) over a network, and carrying out those requests, or causing those requests to be carried out. The hardware may be one physical computer or one physical computer system but neither is required with respect to the present technology. In the present context, the use of the term “server” is not intended to mean that every task (e.g., received instructions or requests) or any particular task will have been received, carried out, or caused to be carried out by the same server (i.e., the same software and/or hardware); it is intended to mean that any amount of software elements or hardware devices may be involved in receiving/sending, carrying out or causing any task or request or the consequences of any task or request to be carried out; and all of this software and hardware can comprise one server or multiple servers, both of which are included within the term “server.”

In the context of the present specification, the expression “information” includes information of any nature and kind whatsoever capable of being stored on an information storage medium. Thus, “information” includes, but is not limited to, audiovisual works (images, video, audio, etc.), data (map data, location data, numerical data, etc.), text (signs, titles, descriptions, warnings, text messages, etc.), documents, spreadsheets, etc.

In the context of the present specification, the expression “probable registered user” includes a person that is probably a registered user. A probable registered user is a person who visited the starting page of a web service, yet, at the time of his identification by the server as the probable registered user, the probable registered user has not provided the complete identification credentials of the user to the server (e.g., has not entered his username and password or the password only, which is necessary to gain access to the web service).

In the context of the present specification, the expression “software component” is meant to include software (appropriate to the particular hardware) that is both necessary and sufficient to achieve the specific function(s) being referenced.

In the context of the present specification, the expression “computer information storage medium,” or simply “computer readable medium,” is intended to include media of any nature and kind whatsoever, including, without limitation, RAM, ROM, disks (CD-ROMs, DVDs, floppy disks, hard drivers, etc.), USB keys, solid state-drives, tape drives, etc. A plurality of components may be combined to form the computer information storage medium, including two or more media components of the same type and/or two or more media components of different types.

In the context of the present specification, the words “first”, “second”, “third” etc. have been used as adjectives only for the purpose of allowing for distinction between the nouns that they modify from one another, and not for the purpose of describing any particular relationship between those nouns. Thus, for example, it should be understood that, the use of the terms “first portion of the content” and “third portion of the content” is not intended to imply any particular order, type, chronology, hierarchy or ranking, nor is their use (by itself) intended to imply that any “second portion of the content” must necessarily exist in any given situation. Moreover, as it has been noted in present description relating to other embodiments of technology, the link to the “first” element and the “second” element does not mean that the two elements can not be implemented as one physical element in the real world. Thus, for example, in some cases “first” server and “second” server could be implemented as the same component of the software and/or hardware, and in some other cases they can be implemented on the different software and/or hardware.

Implementations of the present technology each have at least one of the above mentioned objects and/or aspects, but do not necessarily have all of them. It should be understood that some aspects of the present disclosure that have resulted from attempting to achieve the above mentioned object may not satisfy this object, and/or may satisfy other objects not specifically recited herein.

Additional and/or alternative features, aspects, and advantages of embodiments of the present disclosure will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic representation of the implementation of a network computer system implemented in accordance with non-limiting embodiments of the present technology.

FIG. 2 is a schematic block-diagram of method 200, performed by the server schematically depicted on FIG. 1 the method being implemented in accordance with non-limiting embodiments of the present technology.

### DETAILED DESCRIPTION

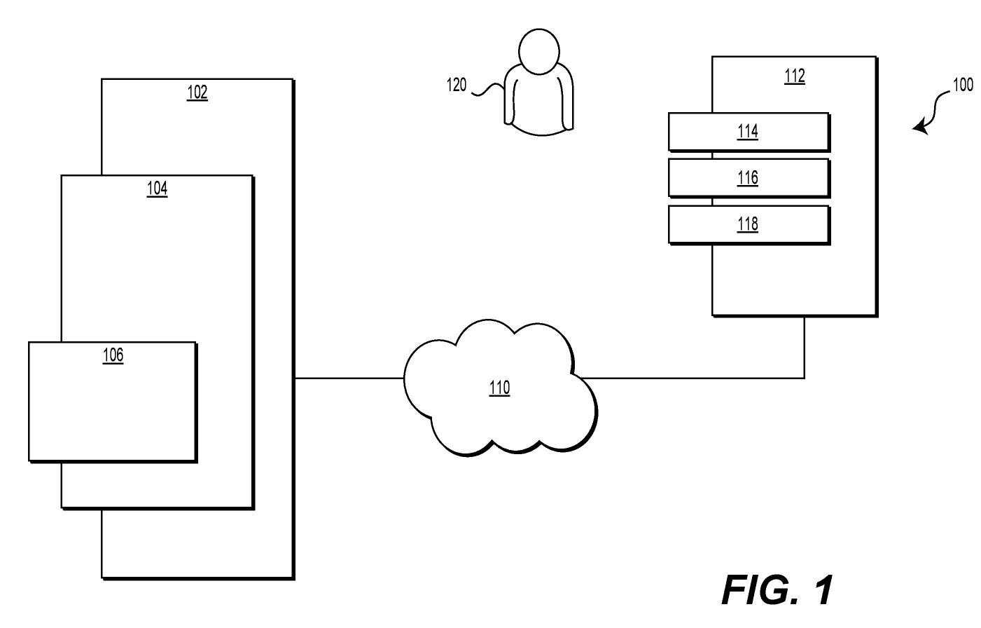

In FIG. 1, there is depicted a schematic diagram of various computer systems 100, which are connected to each other via a communication network 110. It is to be expressly understood that the computer systems 100 are depicted as an illustrative implementation of the present technology. Thus, the description that follows is intended to be only a description of illustrative examples of the present technology. This description is not intended to define the scope or set forth the boundaries of the present technology. Certain useful examples of modifications to the computer systems 100 may also be captured by this description. This is done merely to facilitate understanding and, again, not to define the scope or set forth the boundaries of the present technology. These modifications do not constitute an exhaustive list and, as a person skilled in the art would understand, other modifications are possible. Further, where no examples of modifications have provided, this should not be interpreted as meaning that no modifications are possible and/or that what is described is the sole manner of implementing that element of the present technology. As a person skilled in the art would understand, this is likely not the case. In addition, it is to be understood that the computer systems 100 may provide in certain specific instances a fairly simple implementation of the present technology, which in such cases, has been presented in this manner to facilitate understanding. As person skilled in the art would understand, various implementations of the present technology may be of greater complexity.

The computer system 100 includes a server 102. The server 102 may be implemented as a conventional computer server. In an example of an embodiment of the present technology, the server 102 may be implemented as a Dell™ PowerEdge™ Server running the Microsoft™ Windows Server™ operating system.

Needless to say, the server 102 may be implemented in any other suitable hardware and/or software and/or firmware, or a combination thereof. In the depicted non-limiting embodiment of present technology, the server 102 is a single server. In alternative non-limiting embodiments of the present technology, the functionality of the server 102 may be distributed and may be implemented via multiple servers.

In general, the implementations of the server 102 are well known in the art. Thus, suffice it to note that the server 102 comprises, inter alia, a network communication interface (not shown) for two-way communication of data transmission over the communication network 110; and a processor (not shown) connected to the network communication interface, the processor being configured to execute various routines, including those described below. To that end, the processor may store or have access to computer readable instructions, which, when executed, cause the processor to execute the various routines described herein.

The server 102 includes an information storage medium 104 that might be used by the server 102. Generally, computer usable information storage medium 104 may be implemented as a medium of any nature and kind whatsoever, including RAM, ROM, disks (CD-ROMs, DVDs, floppy disks, hard drivers, etc.), USB keys, solid state-drives, tape drives, etc. and also the combinations thereof.

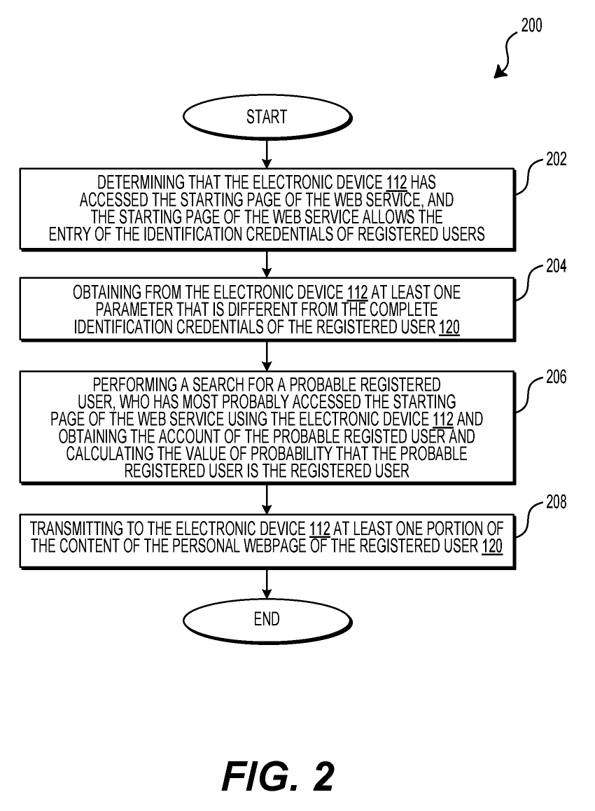

The information storage medium 104 of the server 102 is intended to store data 106, including computer-readable instructions. The computer-readable instructions stored on the information storage medium 104 can provide the server 102 with the ability to perform the steps of the method 200, implemented in accordance with various non-limiting implementations of the present technology, as described below with reference to the flowchart of the method 200 shown in FIG. 2.

In particular, the computer-readable instructions can provide the server 102 with the ability to retrieve from the electronic device 112, which will be described in more detail below, requests for webpages, including the starting page of the web service.

The computer-readable instructions can provide the server 102 with the ability to transmit to the electronic device 112 webpages requested thereby, including the starting page of the web service.

The computer-readable instructions can provide the server 102 with the ability to transmit to the electronic device 112 the web content, including the web content of a personal webpage of the registered user 120. The server 102 may transmit to the electronic device 112 at least a portion of such content either upon or without the request of the registered user 120.

In particular, the computer-readable instructions can provide the server 102 with the ability to determine that the electronic device 112, which will be described in more detail below, has signed into the starting page of the web service.

The computer-readable instructions can provide the server 102 with the ability to receive from the electronic device 112 the identification credentials of the registered user 120 entered registered user 120 on the starting page of the web service by the registered user 120. The identification credentials of the registered user 120 can be any identification credentials of the registered user 120. As a non-limiting example, this could be a combination of a login and a password. As a person skilled in the art would understand, there can be other identification credentials of the user, such as a transaction authentication number (TAN) generated on a mobile generating device, which can be connected to the electronic device 112. As another non-limiting example, the identification credentials of the registered user 120 may consist of a login and information on the fingerprint of the user.

The computer-readable instructions can provide the server 102 with the ability to receive from the electronic device 112 part of the identification credentials of the registered user 120, stored with his consent on the electronic device 112. For example, the server 102 can receive from the electronic device 112 part of the login of the registered user 120 to a web-service, stored with the consent of the registered user 120 on the electronic device 112.

The computer-readable instructions can provide the server 102 with the ability to receive from the electronic device 112 the identification code of the electronic device 112.

The computer-readable instructions can provide the server 102 with the ability to receive from the electronic device 112 information on the software installed on the electronic device 112. As a non-limiting example, such information may be information on the operating system installed on the electronic device, the web browser 116 installed on the electronic device 112 and the additional modules associated with the web browser 116.

The computer-readable instructions may provide the server 102 with the ability to receive from the electronic device 112 information about the hardware contained in the electronic device 112. For example, such information can include information about the information storage medium 114 installed in the electronic device 112, a display 118 (including such characteristics as screen resolution and other characteristics) the installed graphics card and the like.

The computer-readable instructions can provide the server 102 with the ability to receive from the electronic device 112 information about the hardware associated with the electronic device 112. For example, such information can include information about peripheral devices connected to the electronic device 112.

The computer-readable instructions can provide the server 102 with the ability to receive from the electronic device 112 information contained in a cookie file. For example, the server 102 can receive from the electronic device 112 a cookie file generated by the web-service which the registered user 120 is using.

The computer-readable instructions can provide the server 102 with the ability to receive from the electronic device 112 parameters other than the complete identification credentials of the registered user 120. In other words, such parameters can be incomplete identification credentials of the registered user 120. For example, if the complete identification credentials of the registered user 120 are the combination of a login and password then parameters that differ from the complete identification credentials of the registered user 120 can be the login of the registered user 120 to that web-service. The server can obtain parameters that differ from the complete identification credentials of the registered user 120 as well as other information, in particular, by obtaining the information contained in the auto-fill file of the web browser 116, which is stored with the permission of the registered user 120. For example, auto-fill forms can store logins (without passwords) to various web-services used by the registered user 120.

The computer-readable instructions can provide the server 102 with the ability to receive from the electronic device 112 the information showing the behavior patterns of the registered user 120. Thus, each user, including the registered user 120, can have habits that can be recorded. For example, the registered user 120 can be a Frenchman who is living and working in Voronezh, Russia. He may be using the web browser 116 with a French interface. The registered user 120 may be using the electronic device from 9.00 a.m. to 6.00 p.m. on working days, starting with browsing the sites liberation.fr, lefigaro.fr and ici.radio-canada.ca in various order during the first 10-15 minutes, beginning with the launch of the web browser 116 and then proceeding to the starting page of the web service. Information showing the behavior pattern of the registered user 120 can be received by the server 102, as non-limiting example, from the navigation history of the web browser 116 as well as from the settings file of the web browser 116.

The computer-readable instructions can provide the server 102 with the ability to receive from the electronic device 112 the IP address of the electronic device 112.

The computer-readable instructions can provide the server 102 with the ability to receive from the electronic device 112 location information associated with the electronic device 112.

Location information associated with the electronic device 112 can be received either via the IP address of the electronic device 112 or in any other suitable manner. For example, such data can be received from satellite navigation systems modules (not shown) when these modules are installed on the electronic device 112.

Location information associated with the electronic device 112 can be also received by using information associated with the GSM towers most closely located to the electronic device 112 (not shown).

Location information associated with the electronic device 112 can also be received by using the information associated with Wi-Fi™ networks in a coverage area where the electronic device 112 is located. Thus, the server 102 can receive from the electronic device 112 a list of Wi-Fi™ networks in the coverage area where the electronic device 112 is located as well as information about the signal strength of each such network. In case that the server 102 has information about the locations of a plurality of Wi-Fi™ networks in certain localities, and having received from the electronic device 112 the information about the strength of the identified signals, the server 102 may determine the location of the electronic device 112.

The computer-readable instructions can provide the server 102 with the ability to receive from the electronic device 112 a phone number associated with the electronic device 112. This is possible, for example, when the electronic device 112 is implemented as a mobile communication device.

The computer-readable instructions may provide the server 102 with the ability to receive from the electronic device 112 an International Mobile Equipment Identity (IMEI) associated with the electronic device 112. This is possible, for example, when the electronic device 112 is implemented as a mobile communication device.

The computer-readable instructions can provide the server 102 with the ability to receive from the electronic device 112 at least one parameter that is different from the registered user's complete identification credentials. For example, this could be the login of the registered user 120 stored by the web browser 116 on the electronic device 112 with the consent of the registered user 120.

The server 102 may store information received from the electronic device 112 either on the server 102 or on electronic devices to which the server 102 has access. Thus, the server 102 may gather information associated with the registered user 120 and any electronic device that has ever been used by the registered user 120 to access the services of the web service provided by the server 102.

The server 102 may systematize information associated with the registered user 120 and any electronic device that has ever been used by the registered user 120 to access the services of the web service provided by the server 102, and identify the characteristic features of the behavior of the registered user 120 (characteristics of the previous activity of the registered user 120). For example, such systematization may allow to identify certain patterns in the behavior of the registered user 120 such as use of the electronic device 112 during the period from 9.00 a.m. to 6.00 p.m. on working days and use of a second electronic device (not depicted) after 7.30 p.m. on working days and during Saturdays, Sundays and holidays in their entirety. As another non-limiting example, another pattern may be included in the fact that in the vast majority of cases, the registered user 120 navigates to the start page of the web service from the webpage of a particular online news resource, or from the webpage of a specific social network, etc. As an another non-limiting example, another pattern may lie in the fact that the electronic device 112 of the registered user 120 is physically located in Voronezh, Russia, and the transition to the starting page of the web service is done either from foreign sites or from sites on which the information is presented in a foreign language.

The server 102 can receive requests of the electronic device 112 to provide the electronic device 112 with the starting page of the web service, and transmit the starting page of the web service to the electronic device 112. The server 102 may also transmit any other webpage to the electronic device 112.

The starting page of the web service is the webpage where the registered user 120 may enter his/her identification credentials for this web service.

The web service can be a web service of any kind. In one non-limiting example, it may be Yandex.Music™—a service of Yandex that allows users to legally search and listen to songs, albums and audio track compilations for free. As another non-limiting example, the web service may be a service to electronically place reservations in restaurants, a service for generating tax returns, an email service, a cloud storage service, a photo storage service, a service for purchasing movie tickets and other services.

At the time the request for providing the starting page of the web service is received from the electronic device 112, and at the time the starting page of the web service is transmitted to the electronic device 112, it is still unclear whether such a request was made by the registered user 120 or by another person. As such, with varying degrees of probability, a “probable registered user” may be the registered user 120 or any other person. The computer-readable instructions can provide the server 102 with the ability, taking into account the information received from the electronic device 112 and the information stored on the server 102, to determine the probable registered user, who, with the greatest degree of probability, has signed into the starting page of the web service using the electronic device 112, and to receive the account of this probable registered user stored on or accessible by the server 102. For example, after receiving from the electronic device 112 a cookie file, the server 102 may identify as the probable registered user a user of the web service who, using the electronic device 112, accessed the web service from this electronic device 112 and entered his identification credentials.

The computer-readable instructions can provide the server 102 with the ability to compare the characteristics of the current activity of the probable registered user with the characteristics of the previous activity of the registered user 120, stored on the server 102.

The computer-readable instructions can provide the server 102 with the ability, taking into account the results of the comparison of the characteristics of the current activity of the probable registered user with the characteristics of the previous activity of the registered user 120, stored on the server 102, to calculate the value of probability that the probable registered user is the registered user 120. For example, does the behavior of the probable registered user correspond to the typical behavior of the registered user 120. Alternatively or additionally, calculating the value of probability that the probable registered user is the registered user 120 can be performed by comparing other parameters, for example, by comparing the information about the electronic device 112 stored on the server 102 and the information about the electronic device from which the starting page of the web service was signed into at that point in time. For example, while comparing this information, it can be determined that the electronic device from which the starting page of the web service was signed into at that point in time imitates, but is not, the electronic device 112.

The values of probability that the probable registered user is the registered user 120 can be expressed as numbers within a certain interval. For example, such an interval can be set from 0 to 100, where the 0 value means that the probable registered user cannot be the registered user 120, and 100 is the highest possible value of probability that the probable registered user is the registered user 120. For example, the interval from 0 to 50 may indicate a low probability that the probable registered user is the registered user 120; an interval from 50 to 85 may indicate an average probability that the probable registered user is the registered user 120; and an interval from 85 to 100 may indicate a high probability that the probable registered user is the registered user 120. As a person skilled in the art would understand, any other scale is possible.

The server 102 can store on the information storage medium 104 the preset threshold value in such manner that the scale from 0 to 100 will be divided into certain intervals, and each interval will correspond to a different level of probability that the probable registered user is the registered user 120. Such preset intervals can be associated with certain types of data that can be transmitted to the electronic device 112 before the probable registered user has entered the identification credentials of the registered user 120 in the appropriate fields on the starting page of the web service.

The computer-readable instructions can provide the server 102 with the ability to express the calculated value of probability that the probable registered user is the registered user 120 in numeric terms.

The program instructions stored on the information storage medium 104 of the server 102 can cause the processor to execute the steps of the method 200, as described in FIG. 2.

The server 102 is connected to the communication network 110 via a communication link (not numbered). In some embodiments of the present technology, the communication network 110 can be implemented as the Internet. In other embodiments of the present technology, the communication network 110 can be implemented differently, such as any wide-area communication network, local-area communication network, private communication network and so on.

How the communication link is implemented is not particularly limited and will depend on which devices are connected to the communication network 110. As a non-limiting example, the connection of the server 102 to the communication network 110 can be implemented via wired connection (such as an Ethernet-based connection). At the same time, other devices could also be connected in other ways. Thus, in cases where the connected device is implemented as a wireless communication device (e.g. the electronic device 112 implemented as a smartphone), the connection can be implemented as a wireless communication network (such as, but not limited to, a 3G communications network link, a 4G communications network link, Wireless Fidelity or WiFi™ for short, Bluetooth™ and the like). In the examples where the device is implemented as a desktop computer (e.g., the electronic device 112), the communication link can be either wireless or wired (such as an Ethernet-based connection).

It should be expressly understood that various implementations of the server 102, the electronic device 112 and the communication links for the connection to the communication network 110 are provided for illustration purposes only. As such, those skilled in the art will appreciate the details of other specific embodiments of the server 102, the electronic device 112 and the communication links for the connection to the communication network 110. Thus, by no means are the examples provided hereinabove meant to limit the scope of the present technology.

The server 102 can be connected to the electronic device 112 via the communication network 110. The electronic device 112 is typically associated with the registered user 120. The registered user 120 is a person who uses the services of a web service which requires the entry of the identification credentials of the registered user 120 in order to use the services.

It should be noted that the fact that the electronic device 112 is associated with the registered user 120 does not suggest or imply any mode of operation—such as a need to log into the system, but does require the registered user 120 to be a registered user of the web service.

The implementation of the electronic device 112 is not particularly limited, but as an example, the electronic device 112 can be implemented as a personal computer (a desktop, a laptop, a netbook, etc.), a wireless communication device (a cell phone, a smartphone, a tablet, etc.) as well as network equipment (a router, a switch or a gateway).

The electronic device 112, schematically depicted in FIG. 1 is implemented as a personal computer Dell Precision Dell Dimension 4000 with the Windows XP Home SP3 operating system installed, an Intel Pentium 4 processor with a frequency of 1.60 Ghz, 1 GB RAM, a 60 GB HDD, the video card 118 Nvidia GeForce2 MX/MX 400, three USB ports, a CD-RW drive, the VGA, DVI and S-Video ports, a modem and Ethernet.

In other implementations, the electronic device 112 may be implemented as an Apple™ iPhone 5S smartphone running the i057 operating system, with Bluetooth™, Wi-Fi™, 3G, LTE and GPS.

The electronic device 112 also includes the information storage medium 114. Generally, the information storage medium 114 may be implemented as a medium of any nature and kind whatsoever, including RAM, ROM, disks (CD-ROMs, DVDs, floppy disks, hard drives, etc.), USB keys, solid state drives, tape drives, etc., or a combination thereof.

In electronic device 112, schematically depicted at FIG. 1, the information storage medium 114 is implemented as a hard drive with 16 GB of memory. The information storage medium 114 can store user files and program instructions.

More specifically, the information storage medium 114 can store software which executes functions of the web browser 116. Generally, the purpose of the web browser 116 is to allow the registered user 120 to download files to the electronic device 112 via the communication network 110 from the server 102, and display downloaded images (video) on the screen (not shown), which will be described in more detail below.

How the web browser 116 is implemented is not particularly limited. As a non-limiting example, the web browser 116 can be Google Chrome™, Internet Explorer™, Yandex™ Browser, various mobile search applications and the like. It should be expressly understood that any other commercially available or proprietary application can be used for implementing non-limiting embodiments of the present technology.

The electronic device 112 also includes the display 118, which is a Dell™ E2214H 2214-7803 21′5′ monitor with a resolution of 1920×1080, allowing to display to the registered user 120 map images and other video information. As such, the registered user 120 has the ability to see webpages on the display 118 in the interface of the web browser 116 of the electronic device 112, including the starting page of the web service.

FIG. 2 is a schematic flowchart of the method 200, implemented at the server 102, depicted on FIG. 1, the method being implemented in accordance with non-limiting embodiments of the present technology.

Step 202—determining that the electronic device 112 has accessed the starting page of the web service, and the starting page of the web service allows the entry of the identification credentials of registered users

At step 202, the server 102 effects the determining that the electronic device 112 has accessed the starting page of the web service. A starting page of a web service is page where any user, including the registered user 120, can enter his identification credentials.

As a person skilled in the art would understand, the server 102 can receive from the electronic device 112 the request to provide the electronic device 112 with the starting page of the web service (the link to the starting page of the web service) from the server 102. In response to the received request, the server 102 can transmit via communication network 110 the requested starting page of the web service to the electronic device 112. The presence of the request from the electronic device 112 for providing the starting page of the web service, and the transmission of the starting page to the electronic device 112 allow the server 102 to perform the determining that the electronic device 112 has accessed the starting page of the web service.

As a person skilled in the art would understand, the determining that the electronic device 112 has accessed the starting page of the web service can be implemented in any other suitable manner.

Next, the method proceeds to step 204.

Step 204—obtaining from the electronic device 112 at least one parameter that is different from the complete identification credentials of the registered user 120

At step 204, the server 102, after establishing a connection with the electronic device 112 receives from the electronic device 112 the information about the electronic device 112, including the information about certain files stored on the information storage medium 114 of the electronic device 112.

The server 102 can obtain from the electronic device 112 any suitable identification code of the electronic device 112. As a non-limiting example, such an identification code can be an International Mobile Equipment Identity (IMEI).

The server 102 can obtain from the electronic device 112 information about the software installed on the electronic device 112. For example, the server 102 can obtain information about the operating system installed on the electronic device, the web browser 116, add-ons to the web browser 116 and the like.

The server 102 can obtain from the electronic device 112 information about the hardware contained in the electronic device 112. For example, the server 102 can obtain information about the video card installed on the electronic device 112, the display 118 and the like.

The server 102 can obtain from the electronic device 112 information about the hardware associated with the electronic device 112. For example, the server 102 can obtain information about the printer connected to the electronic device and the like.

In cases where the electronic device 112 is a means of mobile communication, the server 102 can obtain the phone number associated with the electronic device 112.

The server 102 can receive from the electronic device 112 information contained in a cookie file. Such information can include information about previous activity on the website of the web service using the electronic device 112.

The server 102 can receive from the electronic device 112 information contained in an auto-fill file of the web browser 116. An auto-fill file of the web browser 116 can contain information that can be entered into certain fields on web forms. For example, when the registered user 120 enters the login for a particular web service, the web browser 116 may recommend to the registered user 120 to store the entered data and then store the data with the consent of the registered user 120. In such manner, the web browser 116 can store multiple logins of the registered user 120 for various web services as well as information other than logins. At the same time, the server 102 does not receive from the registered user 120 the password to the web service. Thus, as a result of executing step 204, the server 102 can obtain information about the electronic device 112, including files that contain information about the person using the electronic device 112, including the incomplete identification credentials of the registered user 120 (e.g., a login), but does not obtain the complete identification credentials of the registered user 120.

Moreover, the server 102 can obtain from the electronic device 112 the settings of the web browser, for example, the interface language and the navigation history of the web browser that stores information about websites visited, the time of the visit, the frequency of visits to certain websites and other information.

The server 102 can obtain from the electronic device 112 information allowing to determine the location of the electronic device 112. For example, this could be information about Wi-Fi™ networks in the coverage area where the electronic device 112 is located and the signal strength of each of such network. The server 102 may also obtain other information allowing to determine the location of the electronic device 112, for example, the IP address of the electronic device 112.

Next, method proceeds to step 206.

Step 206—performing a search for a probable registered user, who has most probably accessed the starting page of the web service using the electronic device 112 and obtaining the account of the probable registered user and calculating the value of probability that the probable registered user is the registered user

At step 206, the server 102, taking into account the information received from the connected electronic device (which may be the electronic device 112 or a different electronic device), and taking into account the information stored on the server 102, performs a search for the probable registered user, who, has most probably accessed the starting page of the web service using the electronic device 112, and receives the account of the probable registered user, stored on the server 102 or accessible by the server 102. The search is performed by matching information obtained during the current connection of the server 102 to the connected electronic device (which may be the electronic device 112 or a different electronic device) and information about a plurality of user profiles and a plurality of electronic devices, including the electronic device 112, stored on the server 102.

In the first step, the server 102 can determine the registered user, who has most probably accessed the starting page of the web service. Such a determination can be effected in any suitable manner. For example, the server 102 can identify the connected electronic device as the electronic device 112, which had previously been connected to the server 102 and on which the web service was used. Then, the server 102 identifies the registered user 120 who used the web service by entering his registration information using the electronic device 112 to do so.

For example, after obtaining a cookie file from the electronic device 112, the server 102 can identify the connected electronic device 112 and the registered user 120, who has previously used the services of the web service, by accessing the corresponding website using the electronic device 112. As such, the person who this time connected to the same web service using the same electronic device 112 is likely to be the registered user 120.

As a person skilled in the art would understand, the search for the probable registered user can be performed using parameters other than the cookie file. For example, incomplete identification credentials stored by the web browser 116, such as a user login to the web service, can be used

At the second step, the server 102 effects the calculating of the value of probability that the probable registered user is the registered user 120. To this end, just as in the first step, the server 102 compares at least one parameter received from the electronic device 112 during the current connection with at least a portion of comparable information stored on the server 102. It is possible (but not necessary) that the server 102 will use different parameters at the first and second step.

The server 102 can also compare the current activity of the probable registered user with the characteristics of the previous activity of the registered user 120, stored on the server 102. As a non-limiting example, if during the first step, to identify the probable registered user, the server 102 used the password of the registered user 120 stored by the web browser 116 or a cookie file, then, at the second stage, the server 102 may compare the behavioral characteristics of the registered user 120, stored on server 102, with the behavioral characteristics of the probable registered user at the moment. For example, the server 102 may compare the time period during which the registered user 120 accessed the services of the web service with the electronic device 112 (if this information is stored on the server 102) with the time of the visit at that moment. For instance, the user always accesses the web service using the electronic device 112 on working days from 9.00 a.m. to 5.30 p.m., and accesses the starting page of the web service from French news sites liberation.fr, lefigaro.fr, or ici.radio-canada.ca; and the probable registered user accessed the starting page of the web service using the electronic device 112 a 1:37 a.m. Tuesday night, and accessed the starting page of the web service from the Russian-language auto site autoboz.ru. Such actions of the first probable registered user do not correspond to the behavioral patterns of the registered user 120. There can be various reasons for this difference in behavior. For example, a working computer can be used by someone other than its owner (for example, a security officer uses someone else's computer in the office at night). As such, the server 102 can calculate the value of probability that the probable registered user is or is not the registered user 120. In order to calculate this value, the server 102 can use at least one parameter that is different from the complete identification credentials of the registered user 120.

In some embodiments of the present technology, the at least one parameter that is different from the complete identification credentials of the registered user 120 can be a parameter, stored on the server 102, characterizing the electronic device 112 and a similar parameter of the electronic device 112, on which the registered user 120 is, at that moment, logged in on the starting page of the web service. For example, in comparing this information, it can be determined that the electronic device on which the starting page of the web service was signed into at that time merely simulates the electronic device 112, but in reality is either not the electronic device 112 or at least a portion of its hardware and/or software has been replaced.

The calculated values of probability that the probable registered user is the registered user 120 may be expressed as a number within a certain interval. For example, such an interval can be set from 0 to 100, where the value of 0 means that the probable registered user cannot be the registered user 120 and the value of 100 is the highest possible value of probability that the probable registered user is the registered user 120.

Next, method 200 proceeds to step 208.

Step 208—transmitting to the electronic device 112 at least one portion of the content of the personal webpage of the registered user 120

At step 208, the server 102 effects the transmitting to the electronic device 112 of at least one portion of the content of the personal webpage of the registered user 120, wherein the selecting of the at least one portion of the content of the personal webpage of the registered user 120, transmitted by the server 102 to the electronic device 112, is determined according to the value of probability that the probable registered user is the registered user 120. As described above, the server 102 can store on the information storage medium 104 the preset threshold value of the value of probability that the probable registered user is or is not the registered user 120 in such manner that the scale from 0 to 100 will be divided into certain intervals, and each interval will correspond to a different level of probability that the probable registered user is the registered user 120. For example, an interval from 0 to 50 may indicate a low probability that the probable registered user is the registered user 120; an interval from 50 to 85 may indicate an average probability that the probable registered user is a registered user 120; an interval from 85 to 100 may indicate a high probability that the probable registered user is the registered user 120. Such preset intervals can be associated with certain types of data that can be transmitted to the electronic device 112 before the probable registered user has entered the identification credentials of the registered user 120 in the appropriate fields on the starting page of the web service. For example, if the probability that the probable registered user is the registered user 120 falls within the 0 to 50 range of the scale, then no data from the web service, usage of which requires the correct complete identification credentials of the registered user 120, will be transmitted to the connected electronic device. If the probability that the probable registered user is the registered user 120 falls within the 50 to 85 range of the scale, a background image and visual styles are transmitted from the web service to the connected electronic device. If the probability of that the probable registered user is the registered user 120 is in the 85 to 100 range of the scale, information about the page layout is transmitted from the web service to the connected electronic device.

The transmission of such information can improve the user experience of the registered user 120, since, after entering the password, the downloading of the content can be accelerated due to the fact that some of the content will be pre-downloaded prior to the entrance and dispatch of the password by the registered user 120.

In some implementations of the present technology, the registered user 120 can be a group of users who are using the one common web service by using the identification credentials of the registered user 120. In this case, the server 102, using the above-described steps of the method 200, verifies whether the probable registered user corresponds to the profile of the collective registered user 120. For example, if the use of the web service on the electronic device 112 occurs daily from 8.00 a.m. to 8.00 p.m., and transitions amongst French, English and Russian sites occur, then the signing in to the starting page of the web service from a Russian site Saturday night can indicate a low probability that the probable registered user refers to the group of the registered user 120.

Within the present description, it should be understood that in each instance where, the receiving of data from any electronic device and/or from any email server and/or from any other server is indicated, the receiving of electronic or any other signal from a suitable electronic device (server, email server) can be used, and the displaying on the device screen can be implemented as the transmission of the signal to the display, comprising certain information, which can further be interpreted in a certain way and at least partially displayed on the screen of the electronic device. The transmission and reception are not always mentioned within the present description to simplify the description and for a better understanding of the present solution. Signals can be transmitted by optical methods (e.g., via fiber-optic connection), by electronic methods (via wired or wireless connection), by mechanical methods (transmission of the pressure, temperature and/or other physical parameters by means of which the transmission of the signal is possible).

### CLAUSES

In accordance with the above description, the present technology can be summarized as follows.

Clause 1: A method of downloading a portion of content of a personal webpage of a registered user (120) of a web service to an electronic device (112), the method executable at a server (102) connected to electronic devices via a communication network, and having access to a plurality of registered accounts of a plurality of users of the web service, each of the registered accounts being associated with data of a corresponding account of a corresponding registered user, the method comprising:
determining that the electronic device (112) has accessed a starting page of the web service, the starting page of the web service being configured to allow entry of identification credentials of registered users;
obtaining from the electronic device (112) at least one parameter that is different from the registered user's (120) complete identification credentials;
before obtaining the registered user's (120) complete identification credentials, based on at least one parameter that is different from the registered user's (120) complete identification credentials, performing a search for a probable registered user, who has most probably, accessed the starting page of the web service using the electronic device (112) and,
responsive to the server (102) locating the probable registered user successfully, acquiring an indication of an account of the probable registered user and calculating a value of probability that the probable registered user is the registered user (120);
transmitting to the electronic device (112), before obtaining the complete identification credentials of the registered user (120), at least one portion of content of the personal webpage of the registered user (120), wherein the at least one portion of content of the personal webpage of the registered user (120) transmitted by the server (102) to the electronic device (112) is determined based on the value of probability that the probable registered user is the registered user (120).

Clause 2: The method of clause 1, wherein the at least one parameter that is different from the registered user's (120) complete identification credentials comprises at least one of an identification code of the electronic device (112), information about the software installed on the electronic device (112), information about the hardware that is part of the electronic device (112), information about the hardware associated with the electronic device (112), information contained in a cookie file, information contained in an auto-fill file of a web browser (116), web browser (116) settings, web browser (116) navigation history, an IP address of the electronic device (112), location information associated with the electronic device (112), a phone number and an international mobile equipment identify (IMEI).

Clause 3: The method of any of clauses 1-2, wherein at least one of the performing the search for the probable registered user and the calculating the value of probability that the probable registered user is the registered user (120) is performed by comparing the at least one parameter that is different from the registered user's complete identification credentials obtained from the electronic device (112) with at least a portion of comparable information stored on the server (102).

Clause 4: The method of clause 3, wherein the server (102) further effects storing of a characteristic of a previous activity of the registered user (120), and at least one of searching for the probable registered user and calculating the value of probability that the probable registered user is the registered user (120) is additionally performed by comparing a characteristic of a current activity of the probable registered user with the characteristic of the previous activity of the registered user (120) stored on the server (102).

Clause 5: The method of clause 4, wherein the characteristics of the previous activity of the user include at least one of a personal preference of the registered user (120), navigation history of the web browser (116) and a temporary pattern of the registered user's (120) behavior.

Clause 6: The method of any of clauses 1-5, wherein
when the value of probability that the probable registered user is the registered user (120) exceeds a first re-determined value, the transmitting comprises sending by the server (102) a first portion of content of the personal webpage of the registered user (120) to the electronic device (112), and
when the value of probability that the probable registered user is the registered user (120) exceeds a second re-determined value, the second re-determined value exceeding the first re-determined value, the transmitting comprises sending by the server (102) the first portion of content of the personal webpage of the registered user (120) and a second portion of content of the personal webpage of the registered user (120) to the electronic device (112).

Clause 7: The method of clause 6, wherein the first portion of the content of the personal webpage of the registered user (120) is at least one of page layout information, a background image and a visual style.

Clause 8: The method of any of clauses 1-7, wherein the registered user (120) is a group of users using one common user account and shared identification credentials, and the probable registered user is a probable member of the group of users using the one common user account and the shared identification credentials.

Clause 9: A server connected to electronic devices via a communication network and having access to a plurality of registered accounts of a plurality of users of the web service, each of the registered accounts being associated with data of a corresponding account of a corresponding registered user, the server (102) including a processor, the processor configured to render the server to effect the method of any of clauses 1-8.

1. A method of downloading a portion of content of a personal webpage of a registered user of a web service to an electronic device, the method executable at a server connected to electronic devices via a communication network, and having access to a plurality of registered accounts of a plurality of users of the web service, each of the registered accounts being associated with data of a corresponding account of a corresponding registered user, the method comprising:
determining that the electronic device has accessed a starting page of the web service, the starting page of the web service being configured to allow entry of identification credentials of registered users, wherein entry of the registered user's complete identification credentials grants access to the content of the personal webpage of the registered user;
obtaining from the electronic device at least one parameter that is different from the registered user's complete identification credentials;
before obtaining the registered user's complete identification credentials, based on at least one parameter that is different from the registered user's complete identification credentials, performing a search for a probable registered user, who has most probably accessed the starting page of the web service using the electronic device;
responsive to the server locating the probable registered user successfully, obtaining an indication of an account of the probable registered user and calculating a value of probability that the probable registered user is the registered user;
transmitting to the electronic device, before obtaining the complete identification credentials of the registered user, at least one portion of content of the personal webpage of the registered user, wherein the at least one portion of content of the personal webpage of the registered user transmitted by the server to the electronic device is determined based on the value of probability that the probable registered user is the registered user; and
after obtaining the complete identification credentials of the registered user, transmitting to the electronic device a remainder of the content of the personal webpage of the registered user.

2. The method of claim 1, wherein the at least one parameter that is different from the registered user's complete identification credentials comprises at least one of an identification code of the electronic device, information about the software installed on the electronic device, information about the hardware that is part of the electronic device, information about the hardware associated with the electronic device, information contained in a cookie file, information contained in an auto-fill file of a web browser, web browser settings, web browser navigation history, an IP address of the electronic device, location information associated with the electronic device, a phone number and an international mobile equipment identify (IMEI).

3. The method of claim 1, wherein at least one of the performing the search for the probable registered user and the calculating the value of probability that the probable registered user is the registered user is performed by comparing the at least one parameter that is different from the registered user's complete identification credentials obtained from the electronic device with at least a portion of comparable information stored on the server.

4. The method of claim 3, wherein the server further effects storing of a characteristic of a previous activity of the registered user, and at least one of searching for the probable registered user and calculating the value of probability that the probable registered user is the registered user is additionally performed by comparing a characteristic of a current activity of the probable registered user with the characteristic of the previous activity of the registered user stored on the server.

5. The method of claim 4, wherein the characteristics of the previous activity of the user include at least one of a personal preference of the registered user, navigation history of the web browser and a temporary pattern of the registered user's behavior.

6. The method of claim 1, wherein
when the value of probability that the probable registered user is the registered user exceeds a first re-determined value, the transmitting comprises sending by the server a first portion of content of the personal webpage of the registered user to the electronic device, and
when the value of probability that the probable registered user is the registered user exceeds a second re-determined value, the second re-determined value exceeding the first re-determined value, the transmitting comprises sending by the server the first portion of content of the personal webpage of the registered user and a second portion of content of the personal webpage of the registered user to the electronic device.

7. The method of claim 6, wherein the first portion of the content of the personal webpage of the registered user is at least one of page layout information, a background image and a visual style.

8. The method of claim 1, wherein the registered user is a group of users using one common user account and shared identification credentials, and the probable registered user is a probable member of the group of users using the one common user account and the shared identification credentials.

9. A server connected to electronic devices via a communication network and having access to a plurality of registered accounts of a plurality of users of the web service, each of the registered accounts being associated with data of a corresponding account of a corresponding registered user, the server including a processor configured to render the server to execute:
determining that the electronic device has accessed a starting page of a web service, the starting page of the web service being configured to allow users to allow entry of identification credentials of registered users, wherein entry of the registered user's complete identification credentials grants access to the content of the personal webpage of the registered user;
obtaining from the given electronic device at least one parameter that is different from the registered user's complete identification credentials;
before obtaining the registered user's complete identification credentials, based on at least one parameter that is different from the registered user's complete identification credentials, performing a search for a probable registered user, who has most probably accessed the starting page of the web service using the electronic device;
if the server located the probable registered user successfully, obtaining an account of the probable registered user and calculating the value of probability that the probable registered user is the registered user;
transmitting to the electronic device, before obtaining the complete identification credentials of the registered user, at least one portion of content of the personal webpage of the registered user, wherein the at least one portion of the content of the personal webpage of the registered user transmitted by the server to the electronic device is determined based on the value of probability that the probable registered user is the registered user; and
after obtaining the complete identification credentials of the registered user, transmitting to the electronic device a remainder of the content of the personal webpage of the registered user.

10. The server of claim 9, wherein the at least one parameter that is different from the registered user's complete identification credentials includes at least one of an identification code of the electronic device, information about the software installed on the electronic device, information about the hardware that is part of the electronic device, information about the hardware associated with the electronic device, information contained in a cookie file, information contained in an auto-fill file of a web browser, web browser settings, web browser navigation history, IP address of the electronic device, location information associated with the electronic device, a phone number and an international mobile equipment identify (IMEI).

11. The server of claim 9, wherein the processor is further configured to render the server to effect at least one of the performing the search for the probable registered user and the calculating the value of probability that the probable registered user is the registered user by comparing the at least one parameter that is different from the registered user's complete identification credentials obtained from the electronic device with at least a portion of comparable information stored on the server.

12. The server of claim 11, wherein the server further effects storing of a characteristic of a previous activity of the registered user, and at least one of the searching for the probable registered user and the calculating the value of probability that the probable registered user is the registered user is additionally performed by comparing a characteristic of a current activity of the probable registered user with the characteristic of the previous activity of the registered user stored on the server.

13. The server of claim 12, wherein the characteristic of the previous activity of the user includes at least one of a personal preference of the registered user, navigation history of the web browser and a temporary pattern of the registered user's behavior.

14. The server of claim 9, wherein the processor is further configured to render the server to execute:
when the value of probability that the probable registered user is the registered user exceeds a first preset value, sending to the electronic device a first portion of content of the personal webpage of the registered user, and
when the value of probability that the probable registered user is the registered user exceeds a second preset value, the second preset value exceeding the first preset value, sending to the electronic device the first portion of content of the personal webpage of the registered user and a second portion of the content of the personal webpage of the registered user.

15. The server of claim 14, wherein the first portion of content of the personal webpage of the registered user is at least one of page layout information, a background image and a visual style.

16. The server of claim 9, wherein the registered user is a group of users using one common user account and shared identification credentials, and the probable registered user is a probable member of the group of users using the one common user account and shared identification credentials.
